(19) United States
(12) Patent Application Publication
(10) Pub. No.: US 2025/0205629 A1
(43) Pub. Date: Jun. 26, 2025

(54) PISTON OPERATED PULSE JET SOLENOID VALVE

(71) Applicant: Rotex Automation Limited, Vadodara (IN)

(72) Inventors: Nirav Shah, Vadodara (IN); Rajesh Shah, Vadodara (IN)

(21) Appl. No.: 18/851,025

(22) PCT Filed: Mar. 25, 2023
(86) PCT No.: PCT/IB2023/052977

§ 371 Date: Sep. 25, 2024

(30) Foreign Application Priority Data
Mar. 25, 2022 (IN) 202221017062

(51) Int. Cl. B01D 46/71; B01D 46/42; F16K 31/06

(52) U.S. Cl. CPC B01D 46/71; B01D 46/4272; F16K 31/06

(57) ABSTRACT

A pilot operated pulse jet solenoid valve 300 includes a pilot piston 308 for sliding motion in a pilot piston bore 322 for opening or closing a valve seat 306 based on actuation of a valve 312 by a solenoid 310. The pilot piston 308 replaces a pilot diaphragm with bleed hole used in conventional pilot operated pulse jet solenoid valves. The pilot piston 308 and the pilot piston bore 322 are dimensioned to have clearance for passage of pressurised air which eliminates the need of a bleed hole, thereby obviating drawbacks associated with the pilot diaphragm and the bleed hole. Further advantages include reducing response time of the pulse jet valve 300, low wear and tear, longer life and no need of higher pressure pilot air supply for actuating the pilot piston 308.

### TECHNICAL FIELD

The present disclosure relates to the field of pulse jet solenoid valve, and more particularly the present disclosure relates to a pulse jet solenoid valve with a pilot piston.

### BACKGROUND

Background description includes information that may be useful in understanding the present invention. It is not an admission that any of the information provided herein is prior art or relevant to the presently claimed invention, or that any publication specifically or implicitly referenced is prior art.

Conventionally, many industries, such as cement industry, power plant, and steel and mineral plant, exhaust air mixed with pollutants to the ambient. This harmful air includes dust particulates that can include harmful chemicals that can cause serious pollution in the environment. Thus, it is mandatory for such industries to treat the exhaust air before releasing it to the environment. This is accomplished by removing dust particles from the exhaust air before releasing it to the atmosphere/ambient/environment. Bag house filters (also referred as dust collectors) are generally used to remove dust particles from the exhaust air before releasing it to the ambient.

In a baghouse, particle-loaded gas is passed through fabric bags and as the fabric filters the dust, the dust gets deposited on the outside surface of the bag. The deposited dust affects efficiency of the filters due to increase in resistance to airflow there-through, thereby leading to pressure drop across the filters. To keep the resistance of the bag-house within a pre-set range, and thus ensure the dust collecting efficiency of the baghouse, bags are cleaned periodically. The most commonly used filter cleaning method is called pulse jet or pressure jet. In this method the dust is removed by a high-pressure blast of air that enters the top of the bags. A pulse jet valve is used to create high-pressure blasts of pulsing air, which create a shock wave that passes through the bag and causes the bag to expand which shatters the dust cake accumulated around the bag.

The shock wave travels down and up the tubular filter bag in around half a second. Therefore, the pulsing air must be strong enough to travel the total length of the bag and fracture the dust cake. The necessary fast opening and closing of dust collector valves that allow pulse jet to enter the bags is achieved by using Pulse Jet Solenoid valves (PJVs) which also control the pulse sequence.

Generally piston operated pulse jet solenoid valves are used for the above discussed purpose, where movement of a piston results in generation of a pulse jet. They are internal or external pilot acting type and include pilot diaphragm on the pilot side which limits sizes of pilot orifice and exhaust port, resulting in higher response time/sluggish operation, higher air consumption, higher power consumption, valve malfunction/jamming, etc. Furthermore, the conventional piston operated pulse jet solenoid valves require a bleed hole in the diaphragm, which results in malfunction of the conventional piston operated pulse jet solenoid valves due to blockage or enlargement of the bleed hole.

There is, therefore, a need of an improved piston operated pulse jet solenoid valve, which is free from above discussed drawbacks of the conventional pulse jet solenoid valves.

### Objects of the Present Invention

A general object of the present disclosure is to provide an improved piston operated pulse jet valve that overcomes the drawbacks of the conventional piston operated pulse jet valves.

An object of the present disclosure is to provide a piston operated pulse jet valve that does not include a diaphragm, thereby overcoming drawbacks associated with the diaphragm.

An object of the present disclosure is to provide a piston operated pulse jet valve that does not include a bleed hole, thereby obviating problem of the pulse jet valve not functioning due to clogging of the bleed hole.

Another object of the present disclosure is to provide a piston operated pulse jet valve that functions satisfactorily at a temperature range comprising lower and higher temperatures compared to conventional piston operated pulse jet valves.

Yet another object of the present disclosure is to provide a piston operated pulse jet valve that has lower response time.

Yet another object of the present disclosure is to provide a piston operated pulse jet valve that consumes lesser pressurized air.

Still another object of the present disclosure is to provide a piston operated pulse jet valve that that does not require pressurized air at a higher pressure for pilot operation.

Still yet another object of the present disclosure is to provide a piston operated pulse jet valve that has lower wear and tear and therefore a longer life.

### SUMMARY OF THE INVENTION

Aspects of the present disclosure relate to a piston operated pulse jet valve typically used with dust filter systems such that a pulse jet from the pulse jet valve is directed to a corresponding filter bag to shake-off dust collected on surface of the filter bag. Specifically, the present disclosure relates to an improved piston operated pulse jet valve that does not include a pilot diaphragm and accordingly obviates drawbacks associated with the diaphragm of the conventional piston operated pulse jet valves.

In an aspect, the disclosed piston operated pulse jet valve (interchangeably referred to as pulse jet valve/PJV, herein) includes a housing that is configured to be mounted on an air manifold. The housing defines a piston bore, a pilot piston bore, an exhaust port and a valve seat. The exhaust port is in fluidic communication with the piston bore such that the valve seat controls flow of pressurized air from the piston bore to the exhaust port.

In an aspect, the pulse jet valve includes a piston slidably configured in the piston bore such that movement of the piston towards the valve seat results in opening of an end of a pipe configured with air manifold such that an opening of the pipe lies within the air manifold. The pipe is further configured to feed a pulse jet.

In an aspect, the pulse jet valve includes a pilot piston configured slidably within the pilot piston bore for movement in a direction perpendicular to the valve seat such that movement of the pilot piston results in opening or closing of the valve seat to respectively allow or prevent flow of the pressurized air from the piston bore to the exhaust port;

In an aspect, under normal condition the pilot piston keeps the valve seat closed, and when a pulse jet is required, the pilot piston is moved away from the valve seat to cause the pressurized air from the piston bore to move out of the exhaust port to result in movement of the piston towards the valve seat. A quick movement of the piston results in the opening of the pipe to open to create a pulse of pressurized air from the air manifold. The pulse moving through the pipe to an outlet of the pipe creating a pulse jet.

In an embodiment, the pulse jet valve may include a solenoid operated valve to control flow of pressurized air directed to act on an outer side of the pilot piston to keep the valve seat closed.

In an embodiment, the solenoid operated valve may be configured such that actuating the solenoid operated valve results in exhausting the pressurized air to ambient, resulting in loss of force on the outer side of the pilot piston.

In an embodiment, the pilot piston may be configured such that the inner side of the pilot piston is subjected to pressure of the pressurized air present in the piston bore, and wherein the loss of force on the outer side of the pilot piston results in the pressure of air present in the piston bore causing the pilot piston to move away from the valve seat to open the valve seat.

In an embodiment, the housing may be configured to be coupled to the air manifold (also known in the art as header) such that the pressurized air from the air manifold acts on the piston to move the piston towards the valve seat.

In an embodiment, the pulse jet valve is characterized by absence of a bleed hole for transfer of the pressurized air from the outer side of the pilot piston to the piston bore. The pilot piston may be dimensioned to have clearance between the pilot piston and the pilot piston bore, such that when the solenoid valve is closed/de-actuated, the transfer of the pressurized air from the outer side of the pilot piston to the piston bore to fill the piston bore with pressurized air takes place through the clearance, resulting in movement of the piston to close the opening of the pipe.

In an embodiment, the solenoid operated valve may be coupled to the air manifold to receive the pressurized air as pilot air.

In an exemplary embodiment, the solenoid operated valve may include a pilot orifice of 5 mm diameter and the exhaust port may be of 30 mm diameter.

In an embodiment, the pilot piston may be made of a material selected from nylon and aluminum.

Various objects, features, aspects, and advantages of the inventive subject matter will become more apparent from the following detailed description of preferred embodiments, along with the accompanying drawing figures in which like numerals represent like components.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

FIG. 1 illustrates a typical filtering system showing a series of PJVs mounted on an air manifold of a bag house filter.

FIG. 2 illustrate cross sectional view of a conventional pulse jet valve that includes a pilot diaphragm.

FIG. 3 illustrates an exemplary sectional view of the proposed piston operated pulse jet valve that includes a pilot piston in place of a pilot diaphragm, mounted in an air manifold, in accordance with embodiments of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

The present disclosure relates to a pulse jet valve, and more particularly the present disclosure relates to a pulse jet valve with a pilot piston replacing a pilot diaphragm.

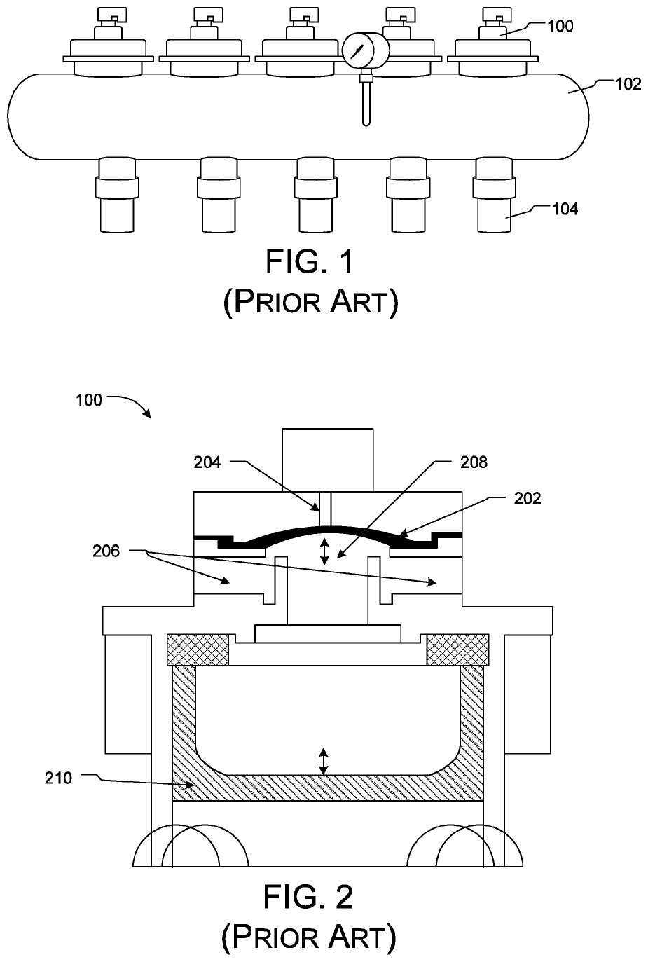

Pulse jet valves are typically used in with dust filter systems to generate pulse jets for removing dust collected on surface of the filter bags of the filter systems. As shown in FIG. 1, the pulse jet valves, such as pulse jet valve 100, are mounted on an air manifold 102. The pulse jet valves 100, on receiving an actuating signal, it generates pulse jets that are transferred through the pipes 104 to feed nozzles located above the filter bag. High pressure blast of air from the nozzles create a shock wave that passes through the bag and causes the bag to expand which shatters the dust cake accumulated around the bag

A cross sectional view of a conventional piston operated pulse jet valve (PJV) 100 is shown in FIG. 2. As shown, the conventional piston operated pulse jet valves include a pilot diaphragm 202 that under normal conditions closes a valve seat 208 under force of pressurized air from an orifice 204. The PJV 100 further includes a piston 210 that is slidable under air pressure from below to push air out through the valve seat 208, when the pressurized air above the diaphragm 202 is exhausted through the orifice 204, such as by actuating a solenoid operated valve. The air pushed by the piston 210 moves out through ports 206 in form of pulse jets due to rapid movement of the piston 210.

However, the conventional PJVs 100 have certain limitation due to vulnerability of the pilot diaphragm 202. Some of these limitations include that the external pilot pressure. i.e., the air pressure applied through the orifice 204 is needed to be higher than air pressure acting on the piston 210 from below. Which is the pressure inside the manifold 102 of the bag house filter. Secondly, if the external pilot pressure exceeds beyond a certain limit, the pilot diaphragm of the PJV 100 can get damaged. Also, size of the orifice 204 for external pilot pressure is small (diameter around 1 mm-2 mm) such that it can get chocked which may lead to malfunctioning of the PJV 100. Also, due to the small size orifice 204, response time of the opening and closing of the valve is high. The conventional PJV 100 also requires a bleed hole provided in the pilot diaphragm 202 for filling up of space above the piston 210, which is prone to blockage or enlargement, which can lead to malfunctioning of the PJV 100.

Furthermore, response time of the pilot diaphragm 202 can vary with ambient conditions. Due to slow operation of the PJVs 100, air consumption is also large. Size of an exhaust port 206 in case of conventional PJVs is small (diameter around 15 mm-26 mm), which also leads to slow opeartion of the PJV 100. Typically, operating temperature range of the conventional PJVs is around −20° C. to −80° C., which hinders use of the conventional PJVs 100 under extreme environmental conditions.

In an aspect, the present disclosure provides a piston operated pulse jet valve that overcomes majority of above mentioned limitations of the conventional PJVs 100. In an aspect, the disclosed piston operated pulse jet valve functions based on a pilot piston which replaces the pilot diaphragm of the conventional PJVs 100, thereby overcoming the limitations of the conventional PJVs 100 on account of the pilot diaphragm 202.

Furthermore, use of a pilot piston enables increase in size of the exhaust port, which cannot be done with a pilot diaphragm without increasing the diameter of the pilot diaphragm due to its inherent characteristics. A larger exhaust port results in quick evacuation of air from the piston bore, thereby quick movement of the piston and better performance of the pulse jet valve.

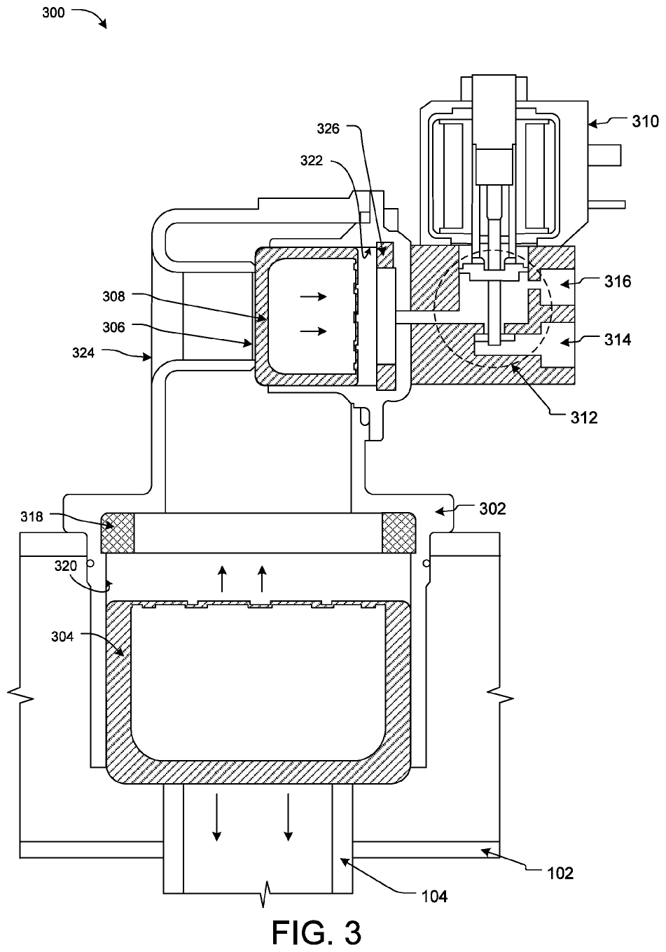

Referring to FIG. 3, where a sectional view of the proposed pulse jet solenoid valve coupled to an air header/manifold, is disclosed, the pulse jet solenoid valve 300 can include a housing 302 that can be coupled to the air manifold 102, as shown. The housing 302 defines a piston bore 320, an exhaust port 324, a valve seat 306 and a pilot piston bore 322. The exhaust port 324 is in fluidic communication with the piston bore 320 with the valve seat 306 controlling flow of pressurized air from the piston bore 320 to the exhaust port 324. A piston 304 is slidably configured in the piston bore 320 such that movement of the piston 304 towards the valve seat 306 results in opening of an upper end (referred to as opening, herein) of a pipe 104 configured in the manifold 102. A quick movement of the piston 304 away from the opening of the pipe 104 results in pressurized air gushing towards the opening for flowing out. This creates a pulse of pressurized air from the air manifold 102, which moves through the pipe 104 to an outlet of the pipe 104 creating a pulse jet.

In an aspect, the PJV 300 includes a pilot piston 308 that is slidably configured in the pilot piston bore 322 for movement perpendicular to the valve seat 306 to open or close fluidic communication between the exhaust port 324 and the piston bore 320, thereby allowing or preventing flow of the pressurized air from the piston bore to the exhaust port. Under normal conditions, the pilot piston 308 keeps the valve seat 306 closed, and when a pulse jet is required, the pilot piston 308 can be moved away from the valve seat 306 to cause the piston 304 to move away from the opening creating a pulse jet, as explained earlier.

In an embodiment, the PJV 300 also includes a bumper 318 configured in the piston bore 320 so that the piston 304, at the end of its movement towards the valve seat 306 is cushioned by the bumper 318 to have a noiseless operation. A similar bumper 326 is provided in pilot piston bore 322 as well to have a noiseless operation.

In an embodiment, the pulse jet valve 300 can also include a solenoid operated valve comprising a solenoid 310 and a 3×2 valve 312 to control flow of pressurized air to the pilot piston bore 322 for acting on an outer side of the pilot piston 308, which, under normal conditions, causes the pilot piston 308 to keep the valve seat 306 closed.

In an embodiment, the solenoid operated valve 310, 312 may be configured such that the valve 312 provides fluidic communication between a pilot port 316 and the pilot piston bore 322 for the pilot piston bore 322 to be under pressure of the pressurized air (pilot air) and keep the valve seat 306 closed in normal condition. Actuating the solenoid 310 operates the valve 312 to exhaust the pressurised air from the pilot piston bore 322 to ambient through the pilot outlet port 314. Exhausting the pressurized air from the pilot piston bore 322 results in loss of force on the outer side of the pilot piston 308. In an embodiment, a large sized outlet port 314 of 5 mm enables fast exhausting of the pressurized air from the pilot piston bore 322 for a quick response.

Further, the pilot piston 308 is configured such that the inner side of the pilot piston 308 is subjected to pressure of the pressurized air present in the piston bore 320. therefore, the loss of force on the outer side of the pilot piston 308 results in the pressure of air present in the piston bore causing the pilot piston 308 to move away from the valve seat 306 to open the valve seat 306 and creating fluidic communication between the piston bore 320 and the exhaust port 324. Therefore, when the solenoid valve 310 is operated, resultant fluidic communication between the piston bore 320 and the exhaust port 324 causes the pressurized air to start flowing out of the piston bore 320 through the valve seat 306, causing reduction in pressure in the piston bore 320, which causes the piston 308 to move upward, i.e. away from the opening of the pipe 104.

In an embodiment, the housing 302 is coupled with the air manifold 102, so that the pressurized air from the air manifold 102 acts on the lower side of the piston 304 to move the piston 304 up towards the valve seat 306. Therefore lower side of the piston 304 is subjected to pressure of the pressurized air from the manifold. When the valve seat 306 is opened, the air pressure acting on the lower side of the piston 304 moves the piston 304 upwards, i.e., towards the valve seat, which also pushes out air from piston bore 320 through the exhaust port 324 quickly.

In an embodiment, the pilot piston 308 and the pilot piston bore 322 are dimensioned to have clearance for the transfer of the pressurized air from the outer side of the pilot piston 308 to the pilot piston bore 322 and fill the piston bore 320 with pressurized air, when the solenoid 310 is deactivated to close the valve seat 306. Filling of the pilot piston bore 322 with pressurized air moves the piston 304 down to close the opening of the pipe 104.

In an embodiment, the pulse jet valve 300 can function at pilot air pressure same or more than the air pressure in the manifold. Therefore, the pilot port 316 of the valve 312 can be coupled to the air manifold 102 to receive the pressurized air as pilot air. This is because, when the piston 304 is lifted up, air gushing out of the pipe 104 shall have lower pressure, as can be understood from the Bernoulli's principle. Upper side of the piston 304 shall have a pressure equal to the manifold pressure due to filling of the piston bore 320 due to transfer of air through the clearance between the pilot piston bore 322 and the pilot piston 308. The pressure difference shall cause the piston 304 to move down and close the opening of the pipe 104.

In an embodiment, the piston 304 and the piston bore 320 can also be dimensioned to have clearance for the transfer of the pressurized air from the lower side of the piston 304 (from manifold 102) to the piston bore 320 for quick filling of the piston bore 320 with pressurized air, when the solenoid 310 is deactivated. Filling of the piston bore 320 with pressurized air moves the piston 304 down towards the pipe 104 to close the opening of the pipe 104.

In an embodiment, the pilot piston 308 can be made of a light weight material, such as, but not limited to, material selected from nylon and aluminum. Housing 302 can also be made of aluminum for a light weight PJV 300.

Thus, the pilot operated pulse jet valves 300 overcomes drawbacks of the conventional piston operated pilot diaphragm pulse jet valve and it is longer lasting.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Invention

The present disclosure provides an improved piston operated pulse jet valve that overcomes the drawbacks of the conventional piston operated pulse jet valves.

The present disclosure provides a piston operated pulse jet valve that does not include a diaphragm, thereby overcoming drawbacks associated with the diaphragm.

The present disclosure provides a piston operated pulse jet valve that does not include a diaphragm with bleed hole, thereby obviating problem of the pulse jet valve not functioning due to clogging of the bleed hole.

The present disclosure provides a piston operated pulse jet valve that functions satisfactorily at a temperature range comprising lower and higher temperatures compared to conventional piston operated pulse jet valves.

The present disclosure provides a piston operated pulse jet valve that has lower response time.

The present disclosure provides a piston operated pulse jet valve that consumes lesser pressurized air.

The present disclosure provides a piston operated pulse jet valve that does not require pressurized air at a higher pressure for pilot operation.

The present disclosure provides a piston operated pulse jet valve that has lower wear and tear and therefore a longer life.

1. A piston operated pulse jet valve, the pulse jet valve comprising:
a housing configured to be coupled to an air manifold, the housing defining a piston bore, a pilot piston bore, an exhaust port and a valve seat; wherein the exhaust port is in fluidic communication with the piston bore such that the valve seat controls flow of pressurized air from the piston bore to the exhaust port;
a piston slidably configured in the piston bore such that movement of the piston towards the valve seat results in opening of an end of a pipe configured to feed a pulse jet, the pipe being configured with air manifold with the opening of the pipe being within the air manifold; and
a pilot piston configured slidably within the pilot piston bore for movement in a direction perpendicular to the valve seat such that movement of the pilot piston results in opening or closing of the valve seat to respectively allow or prevent flow of the pressurized air from the piston bore to the exhaust port;
wherein under normal condition, the pilot piston keeps the valve seat closed, and when a pulse jet is required, the pilot piston is moved away from the valve seat to cause the pressurized air from the piston bore to move out of the exhaust port to result in movement of the piston towards the valve seat to open the opening of the pipe to create a pulse of pressurized air from the air manifold due to quick movement of the piston, the pulse moving through the pipe to an outlet of the pipe creating a pulse jet.

2. The pulse jet valve as claimed in claim 1, wherein the pulse jet valve comprises a solenoid operated valve to control flow of pressurized air, the pressurized air being directed to act on an outer side of the pilot piston to keep the valve seat closed.

3. The pulse jet valve as claimed in claim 2, wherein the solenoid operated valve is configured such that actuating the solenoid operated valve results in exhausting the pressurized air from the pilot piston bore to ambient, resulting in loss of force on the outer side of the pilot piston.

4. The pulse jet valve as claimed in claim 3, wherein the pilot piston is configured such that the inner side of the pilot piston is subjected to pressure of the pressurized air present in the piston bore, and wherein the loss of force on the outer side of the pilot piston results in the pressure of air present in the piston bore causing the pilot piston to move away from the valve seat to open the valve seat.

5. The pulse jet valve as claimed in claim 4, wherein the housing is coupled to an air manifold such that the pressurized air from the air manifold acts on the piston to move the piston towards the valve seat.

6. The pulse jet valve as claimed in claim 5, wherein the pulse jet valve is characterized by absence of a pilot diaphragm with bleed hole for transfer of the pressurized air from the outer side of the pilot piston to the piston bore, wherein the pilot piston and the pilot piston bore are dimensioned to have clearance between them the pilot piston and the pilot piston bore for the transfer of the pressurized air from the outer side of the pilot piston to the piston bore, to fill the piston bore with the pressurized air and move the piston towards the opening of the tube to close the opening.

7. The pulse jet valve as claimed in claim 5, wherein the solenoid operated valve is coupled to the air manifold to receive the pressurized air as pilot air.

8. The pulse jet valve as claimed in claim 5, wherein the solenoid operated valve comprises a pilot orifice of 5 mm diameter, and wherein the exhaust port of the pulse jet valve is of 30 mm diameter.

9. The pulse jet valve as claimed in claim 1, wherein the pilot piston is made of a material selected from nylon and aluminum.

10. The pulse jet valve as claimed in claim 1, wherein the pulse jet valve is configured for use with a dust filter system such that the pulse jet from the pulse jet valve is directed to a corresponding filter bag to shake-off dust collected on surface of the filter bag.
